(19) United States
(12) Patent Application Publication
(10) Pub. No.: US 2010/0121716 A1
(43) Pub. Date: May 13, 2010

(54) ACTIVITY-BASED TARGETED ADVERTISING

(76) Inventor: Jonathan Golan, Englewood, CO (US)

Correspondence Address: FOLEY & LARDNER LLP, 111 HUNTINGTON AVENUE, 26TH FLOOR, BOSTON, MA, 02199-7610, US

(21) Appl. No.: 12/269,371

(22) Filed: Nov. 12, 2008

(51) Int. Cl. G06Q 30/00; G01S 1/00

(52) U.S. Cl. 705/14.58; 342/357.09

(57) ABSTRACT

The system and methods described herein deliver activity-based targeted messages to a device.

In embodiments, a method comprises receiving a first signal; determining, based upon the first signal, a current location and speed of a device; determining an activity of a user of the device based upon at least one of the device's current location and current speed; selecting a message based upon the activity of the user; and transmitting the message.

In embodiments, a system is presented comprising a receiver adapted to receive a first signal; a component adapted to determine, based upon the first signal, a current location and speed of a device; a component adapted to determine an activity of a user of the device based upon at least one of the device's current location and speed; a component adapted to select a message based upon the activity; and a transmitter adapted to transmit the message.

### BACKGROUND

This application relates to systems and methods for delivering targeted advertising to consumers, and in particular to systems and methods for determining a user's activity and selecting advertising targeted for that activity.

### SUMMARY

The system and methods described herein determine not only a user's location but also a user's activity, delivering activity-based targeted messages to a user device for display to the user.

According to one aspect, a method is presented comprising receiving at least one first signal; determining, based at least in part upon the first signal, a current location and a current speed of a device; determining an activity of a user of the device based at least in part upon at least one of the device's current location and the device's current speed; selecting a message based at least in part upon the activity of the user; and transmitting the message. In some embodiments, the first signal is transmitted by the device. In further embodiments, the first signal comprises at least two Global System for Mobile communications (“GSM”) signals transmitted by the device. In still further embodiments, the first signal comprises a signal encoding the device's current location and the device's current speed.

In some embodiments, the device's current location and the device's current speed are determined by the device. In further embodiments, the device's current location and the device's current speed are determined based at least in part upon a plurality of second signals. In still further embodiments, the plurality of second signals comprises a plurality of GSM signals. In still further embodiments, the plurality of second signals comprises a plurality of Global Positioning (“GPS”) signals.

In some embodiments, determining the activity of the user further comprises determining the activity of the user based at least in part upon the device's current speed and direction. In further embodiments, determining the device's current location further comprises determining a class of location. In still further embodiments, determining the device's current location further comprises determining a specific location. In still further embodiments, determining the activity of the user further comprises selecting from a plurality of activities an activity having an activity template most closely matching the device's current location and current speed. In still further embodiments, determining the activity of the user further comprises selecting from a plurality of activities an activity having an activity template most closely matching the device's current location, current speed, and current direction.

In some embodiments, the message is an advertisement. In further embodiments, the advertisement advertises a product or service selected based at least in part upon the user activity.

According to another aspect, a system is presented comprising a receiver adapted to receive at least one first signal; a component adapted to determine, based at least in part upon the at least one first signal, a current location and a current speed of a device; a component adapted to determine an activity of a user of the device based at least in part upon at least one of the device's current location and the device's current speed; a component adapted to select a message based at least in part upon the activity of the user; and a transmitter adapted to transmit the message.

In some embodiments, the first signal is transmitted by the device. In further embodiments, the first signal comprises at least two GSM signals transmitted by the device. In still further embodiments, the first signal comprises a signal encoding the device's current location and the device's current speed.

In still further embodiments, the device's current location and the device's current speed are determined by the device. In still further embodiments, the device's current location and the device's current speed are determined based at least in part upon a plurality of second signals. In still further embodiments, the plurality of second signals comprises a plurality of GSM signals. In still further embodiments, the plurality of second signals comprises a plurality of GPS signals.

In some embodiments, the component adapted to determine the activity of the user is further adapted to determine the activity of the user based at least in part upon the device's current speed and direction. In further embodiments, the component adapted to determine the device's current location is further adapted to determine a class of location. In still further embodiments, the component adapted to determine the device's current location is further adapted to determine a specific location. In still further embodiments, the component adapted to determine the activity of the user is further adapted to select from a plurality of activities an activity having an activity template most closely matching the device's current location and current speed. In still further embodiments, the component adapted to determine the activity of the user is further adapted to select from a plurality of activities an activity having an activity template most closely matching the device's current location, current speed, and current direction.

In some embodiments, the message is an advertisement. In further embodiments, the advertisement advertises a product or service selected based at least in part upon the user activity.

According to another aspect, a mobile device is presented comprising a transmitter adapted to send at least one first signal; a message comprising content that is based at least in part upon a selected activity of a user of the mobile device, wherein the activity is selected based at least in part upon the at least one first signal; and a receiver coupled to the transmitter and adapted to receive the message.

In some embodiments, the first signal comprises at least two GSM signals. In further embodiments, the first signal comprises a second signal encoding a current location of the mobile device and a current speed of the mobile device.

In some embodiments, a mobile device further comprises a component adapted to determine the current location of the mobile device and the current speed of the mobile device. In further embodiments, the component is further adapted to determine the current location of the mobile device and the current speed of the mobile device based at least in part upon a plurality of third signals. In still further embodiments, the plurality of third signals comprises a plurality of GSM signals. In still further embodiments, the plurality of third signals comprises a plurality of GPS signals.

In still further embodiments, a mobile device further comprises a display adapted to display at least a portion of the message.

According to another aspect, a system is presented comprising a component adapted to receive a plurality of first signals; a component adapted to determine, based at least in part upon at least some of the plurality of first signals, a current location and a current speed of the system; a component adapted to determine an activity of a user of the system based at least in part upon at least one of the current location of the system and the current speed of the system; a transmitter adapted to transmit the activity of the user; and a component adapted to receive a message based at least in part upon the activity of the user.

In some embodiments, the plurality of first signals comprises a plurality of signals emitted by at least one cell tower. In further embodiments, the plurality of first signals comprises a plurality of signals emitted by a plurality of GPS satellites.

In some embodiments, the component adapted to determine the current location of the system and current speed of the system is further adapted to determine a current direction of the system. In further embodiments, the component adapted to determine the activity of the user is further adapted to determine the activity of the user based at least in part upon at least one of the system's current location, the system's current speed, and the system's current direction.

In some embodiments, the system further comprises a display adapted to display at least a portion of the message.

In some embodiments, the component adapted to determine the system's current location is further adapted to determine a class of location. In still further embodiments, the component adapted to determine the system's current location is further adapted to determine a specific location. In still further embodiments, the component adapted to determine the activity of the user is further adapted to select from a plurality of activities an activity having an activity template most closely matching the system's current location and current speed. In still further embodiments, the component adapted to determine the activity of the user is further adapted to select from a plurality of activities an activity having an activity template most closely matching the user's current location, current speed and current direction.

In some embodiments, the message is an advertisement. In further embodiments, advertisement advertises a product or service selected based at least in part upon the user activity.

According to another aspect, a method is presented comprising receiving a plurality of first signals; determining, based at least in part upon at least some of the plurality of first signals, a current location and a current speed of a device; determining an activity of a user of the device based at least in part upon at least one of the device's current location and the device's current speed; transmitting the activity of the user; and receiving a message based at least in part upon the activity of the user.

In some embodiments, receiving the plurality of first signals comprises receiving a plurality of signals emitted by at least one cell tower. In further embodiments, receiving the plurality of first signals comprises receiving a plurality of signals emitted by a plurality of GPS satellites.

In some embodiments, determining the current location of the device and current speed of the device further comprises determining a current direction of the device. In further embodiments, determining the activity of the user further comprises determining the activity of the user based at least in part upon at least one of the device's current location, the of the device's current speed, and the device's current direction.

In some embodiments, the method further comprises displaying at least a portion of the message.

In some embodiments, determining the device's current location further comprises determining a class of location. In further embodiments, determining the device's current location further comprises determining a specific location.

In some embodiments, determining the activity further comprises selecting from a plurality of activities an activity having an activity template most closely matching the device's current location and current speed. In further embodiments, determining the activity further comprises selecting from a plurality of activities an activity having an activity template most closely matching the device's current location, current speed, and current direction.

In some embodiments, message is an advertisement. In further embodiments, the advertisement advertises a product or service selected based at least in part upon the user activity.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a schematic illustration of an environment in which an embodiment of a system or method for delivering activity-based targeted advertising is implemented;

FIG. 1B is a schematic illustration of an environment in which an embodiment of a system or method for delivering activity-based targeted advertising is implemented;

FIG. 2 is a schematic illustration of an environment in which an embodiment of a system or method for delivering activity-based targeted advertising is implemented;

FIG. 3A is a flow chart illustrating an embodiment of a method for delivering activity-based targeted advertising;

FIG. 3B is a flow chart illustrating an embodiment of a method for receiving activity-based targeted advertising;

FIG. 4 is a schematic illustration of an implementation of a data structure containing activity templates; and

FIG. 5 is a schematic illustration of an implementation of a data structure containing activity templates.

### DETAILED DESCRIPTION

The systems and methods of this disclosure are not limited in their application to the details of construction and the arrangement of components set forth in the following description or illustrated in the drawings. The systems and methods are capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Described herein are systems and methods for providing a user with a targeted message, such as an advertisement, selected based upon an activity in which the user is determined to be engaged. In embodiments, the user's activity is determined based upon one or more signals carrying information from which the user's position and speed and/or direction of movement may be determined. A message is chosen based upon the determined activity, such as an advertisement for a product or service of relevance to the activity. The selected message is transmitted for display on a device viewable by the user.

For example, a trail runner may carry a mobile device for use in case of emergency. From the runner's location (for example, in a park) and the runner's speed (for example, between 4 mph and 14 mph), it can be determined that the runner's activity is trail running. Showing an advertisement for a nearby gas station, then, may be inappropriate or not particularly of interest to the trail runner. However, showing an advertisement for a sports drink available at the gas station is not only geographically in context, but also in context with the runner's current activity, and therefore with the runner's immediate needs. Thus, by using information about both the user's location and the user's speed of motion to determine the user's activity, better targeting of advertisements can be achieved.

Various embodiments of examples of systems and methods are described below with reference to the figures.

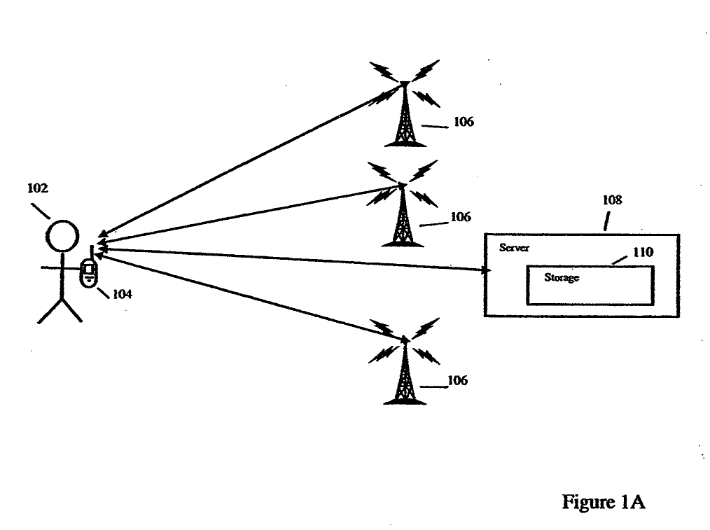

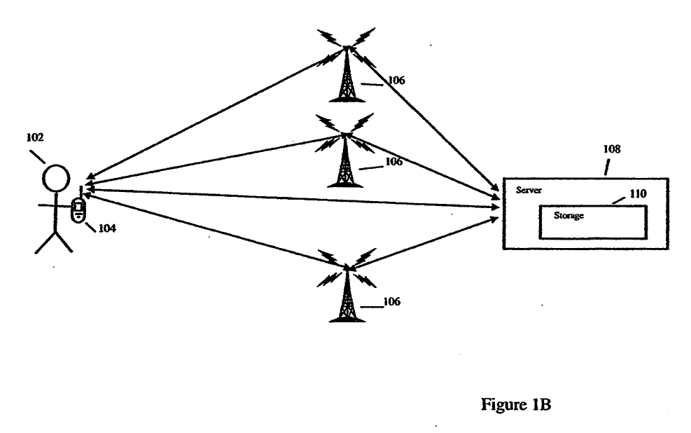

An example of an environment in which examples of embodiments of the systems and methods described herein may be deployed is illustrated in FIG. 1A and FIG. 1B. In both figures, a user 102 carries a mobile device 104 that is in communication with one or more communication towers 106. Mobile device 104 may include a device such as a cellular phone, personal digital assistant (“PDA”), BLACKBERRY electronic device, iPhone, Google phone, or any other wireless communication device, laptop or other portable computer, portable music player, automotive navigator or automotive assistance device, any similar mobile device, or any other device capable of sending or receiving electromagnetic signals.

In embodiments, communication towers 106 are cell phone towers. In other embodiments, communication towers 106 are receiving stations for radio communications such as the signals sent and received by BLACKBERRY devices, wi-fi devices, other wireless devices, or any other mobile devices that can communicate with communications stations such as fixed communications stations. Communication towers 106 may not be literal towers; in embodiments a communication tower 106 may be any communications station or similar location equipped to send and/or receive communications, wirelessly and/or by wire, via the internet or by any other suitable protocol. Communication towers 106 may include any kind of communication station capable of sending and/or receiving information from which the instantaneous location of mobile device 104 can be determined, whether determined by a component of the mobile device 104 itself, by a component located at a communication tower 106, or a component located elsewhere (such as server 108).

In the embodiment illustrated in FIG. 1A, mobile device 104 communicates with one or more communication towers 106 wirelessly and/or by wire, via the internet, or by any other suitable protocol. Using signals transmitted from the communication towers 106, a component of mobile device 104 may, in embodiments, determine its own location (i.e., a location of the user holding the mobile device, a location of a car in which the mobile device is traveling, etc.). The determination of the location of the mobile device may be achieved through any of the many suitable techniques for locating mobile devices. For example, where mobile device 104 is a cellular phone and communication towers 106 are cellular communication towers, the mobile device may determine its current location by interpreting signals from one or more communication towers 106. In embodiments, mobile device 104 may triangulate signals (such as GSM signals) from multiple communication towers 106. Similarly, a BLACKBERRY device, wi-fi, or other wireless communication device may also determine its current location by triangulating signals from a plurality of communication towers 106.

The mobile device 104 may also determine its current traveling speed (i.e., a speed of motion of the user holding the mobile device, a speed of motion of a car in which the mobile device is traveling, etc.), for example, by comparing two determinations of location with a known time interval between them. As used herein, the term “speed” may refer to either scalar speed or vector velocity (i.e. speed and direction). Thus, where a first location determination yields a latitude and longitude of (lat₁, long₁), and a second location determination taken at a time Δt later yields a latitude and longitude of (lat₂, long₂), the mobile device 104 may compute its current speed (defined here as the average speed over the interval Δt) as follows:

$${v}_{AV} = \frac{\sqrt{{( {lat}_{2} - {lat}_{1} )}^{2} + {( {long}_{2} - {long}_{1} )}^{2}}}{Δ t} \qquad Eq . ( 1 )$$

A direction of motion may also be determined by any suitable mathematical approach. In some embodiments, the location may also include an altitude component. The altitude component may be included in a determination of an activity (e.g., in transit in an airplane). The altitude component may also be included in the determination of the speed by extension of equation (1).

Thus in some embodiments a component of the mobile device 104 may determine the mobile device's current location and current speed (which may include a scalar speed and/or a vector velocity) based upon signals received from communications towers 106. Determining the location of the mobile device may include determining location coordinates, as in the example above. In other embodiments, determining the location includes determining, based upon such coordinates, a general class of location (e.g., hotel, airport, highway, supermarket, private home). In other embodiments, determining the location includes determining, based upon such coordinates, a specific location (e.g., at a MARRIOTT hotel, at the Boston-Cambridge MARRIOTT hotel, on I-90, at Logan airport). Determining the location may also include any combination of the previous. The component of mobile device 104 that performs this determination may be implemented in software, hardware, or a combination of the two. For example, the mobile device 104 may include software running on a processing unit, the software being adapted to determine location and/or speed from signals received by the mobile device's receiver unit and passed to the processing unit. In alternative embodiments, the mobile device 104 may have hardware that is hard-coded or configured to determine location and/or speed.

In the embodiment illustrated in FIG. 1A, having determined the current location and current speed of the mobile device 104 (and, by extension, the current location and current speed of the user 102), mobile device 104 transmits its current location and current speed to server 108. Server 108 may be any server computer at any location that can communicate with mobile device 104. In embodiments, server 108 may communicate with mobile device 104 via the internet. For example, server 108 may include a web service application that can receive communications from and/or send communications to mobile device 104 via the internet. In general, server 108 may communicate with mobile device 104 wirelessly and/or by wire, via the internet or by any other suitable protocol.

Server 108 includes or is in communication with storage 110 in which is stored information relating a plurality of user activities to locations and speeds. For example, storage 110 may include a database, such as a relational database, or any other data structure relating user activities to combinations of location and speed, as discussed further below. In embodiments, server 108 determines a user activity which is selected based at least in part upon one or more of the current location and current speed of the mobile device 104. For example, the user activity may be selected from a data structure stored in storage 110 that relates various user activities to locations and speeds, as discussed further below.

Having determined a user activity, server 108 selects a message for transmission to mobile device 104. The message may include any information transmitted to a mobile device 104, such as an advertisement, travel advisory, traffic information, other news message, or any other message. In embodiments the message is selected based upon the determined user activity. For example, if the user activity is determined to be sailing (based, for example, on a location within a body of water and a speed of less than 30 mph), the message may include a weather advisory, an advertisement for a restaurant close to the nearest marina, or an advertisement for a sailing gear company. Similarly if the user activity is determined to be waiting for a flight (based, for example, on a location within an airport terminal and a speed of 0 mph), the message may include advisories from the Transportation Safety Administration, an advertisement for a hotel located near the terminal, or an advertisement for a restaurant located within the terminal. Many other suitable relationships will be appreciated to exist between determined activities and selected messages.

The selected message may be transmitted by a transmitter controlled by server 108. Such a transmitter may, in embodiments, include any kind of transmitter adapted to send a signal wirelessly and/or by wire, via the internet or by any other suitable protocol. The transmitter may include a module or component of a circuit, chip, or device that is adapted to deliver a signal via an output, wirelessly and/or by wire, via the internet or by any other suitable protocol. Thus, in embodiments, the message is encoded and transmitted to the mobile device 104 by server 108.

The embodiment illustrated in FIG. 1B is similar to that described in connection with 1A above. In the embodiment illustrated in FIG. 1B, mobile device 104 communicates with one or more communication towers 106. One or more of communication towers 106 in turn communicates with server 108. Server 108 may then determine the current location and/or current speed of the mobile device 104 as described above, as well as determine a corresponding user activity and select and transmit an appropriate message as described above.

In still a further embodiment that is a variation on FIG. 1B, the current location and/or current speed of the mobile device 104 may be computed by hardware and/or software implemented at one or more of communication towers 106 and then provided to server 108 for determination of the user activity and message as described above. In such an embodiment communication towers 106 may communicate with each other to transmit any information necessary to determine the location and speed of mobile device 104.

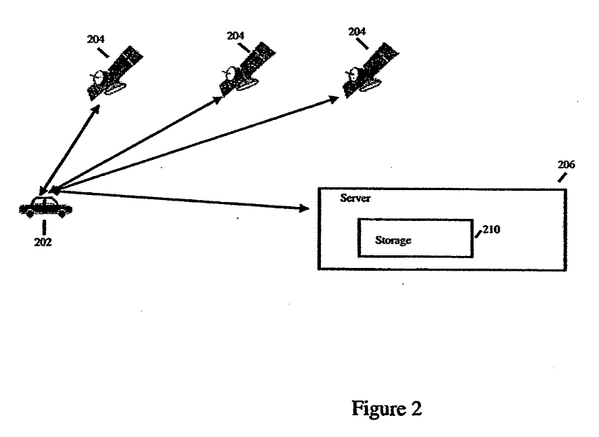

FIG. 2 illustrates an embodiment in which the mobile device is a GPS device in communication with GPS satellites 204. In FIG. 2 GPS device 202 is an automobile equipped with GPS communications hardware and software. More generally GPS device 202 may be any device capable of determining a position and/or speed (or speed and direction) based upon the GPS system of satellites. GPS device 202 may be a handheld navigation system, a navigation system for use in automobiles, and/or a GPS system embedded in another device such a cellular phone, a laptop computer, a PDA, or in any other device. Using signals transmitted by the GPS satellites 204, GPS device 202 determines its own location according to known methods. GPS device 202 may also determine its current speed and/or direction of motion, similar to the embodiment discussed above in connection with FIG. 1A.

In embodiments, GPS device 202 transmits its current location and/or current speed to server 206, again as discussed above in connection with FIG. 1A. Server 206 may determine an activity based upon the current location and current speed. Server 206 may then select a message based upon the determined activity and transmit the message to GPS device 202, again as discussed above in connection with FIG. 1A.

Embodiments may include different ways of transmitting the user's location and/or velocity information to the server. In embodiments, data from which the location of mobile device 104 can be determined is transmitted from communication towers 106 to server 108, which uses the data to compute a location and speed of mobile device 104, and determines a user activity based upon the location and speed. Server 108 may then determine a message based upon the user activity and transmit the message to the mobile device 104.

In further embodiments, data from which the location of mobile device 104 (or GPS device 202) can be determined is transmitted from communication towers 106 (or satellites 204) to mobile device 104 (or GPS device 202). Mobile device 104 (or GPS device 202) determines its own location and transmits its location to server 108/206. Server 108/206 may then compute a speed from successive location points, and determine a user activity based upon the location and speed of mobile device 104 (or GPS device 202). Server 108/206 may then determine a message based upon the user activity and transmit the message to the mobile device 104 (or GPS device 202).

In still further embodiments, data from which the location of mobile device 104 (or GPS device 202) can be determined is transmitted to mobile device 104 (or GPS device 202), which computes its own location and speed. Mobile device 104 (or GPS device 202) may then transmit its location and speed to server 108/206, which determines a user activity. Server 108/206 may then determine a message based upon the user activity and transmit the message to the mobile device 104 (or GPS device 202).

In still further embodiments, the mobile device 104 (or GPS device 202) may store an activity database locally. In such embodiments, data from which the location of mobile device 104 (or GPS device 202) can be determined is transmitted to mobile device 104 (or GPS device 202), which computes its own location and speed. Mobile device 104 (or GPS device 202) may then determine an activity from the local activity database, based upon the determined location and speed. Mobile device 104 (or GPS device 202) may transmit the activity to the server 108/206, which determines a message based upon the user activity and transmit the message to the mobile device 104 (or GPS device 202).

Thus, a “signal” transmitted by a device or received by a server may, in embodiments, include one or more of the following: an activity; information from which an activity may be determined; a location and/or a speed (scalar or vector); and/or information from which a location and/or a speed (scalar or vector) can be determined.

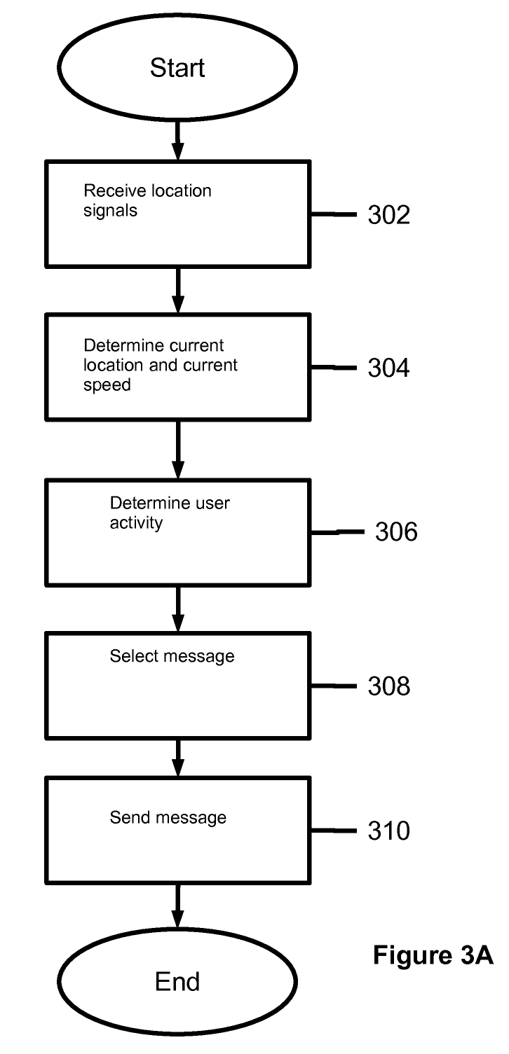

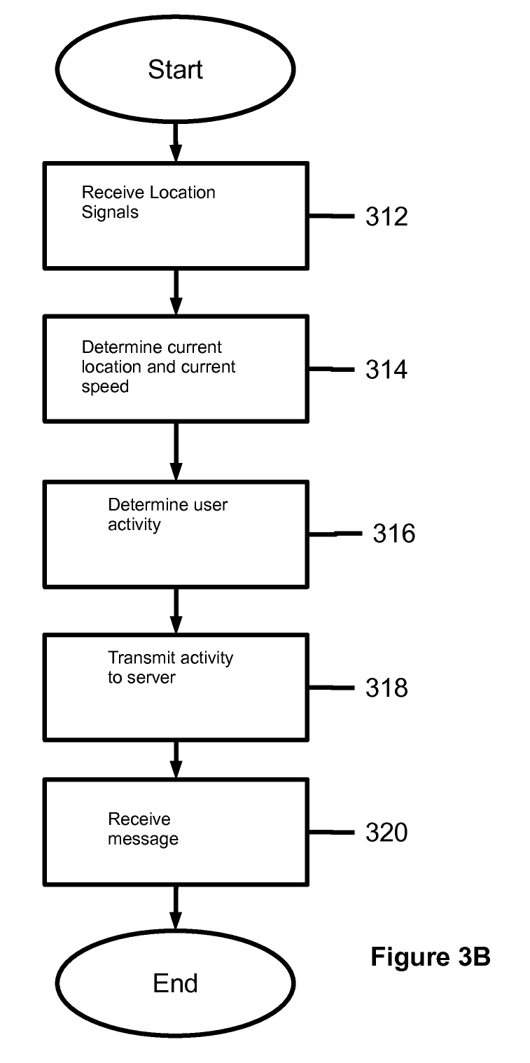

FIGS. 3A and 3B illustrate processes that may be performed in examples of embodiments such as those described herein. These processes may be performed by components implemented in mobile device 104 (or GPS device 202), server 108/206, or combinations thereof. “Components” may include implementations in hardware, in software, or in combinations thereof.

FIG. 3A illustrates a process that may be implemented, for example, at a server such as server 108 or server 206 discussed above. At block 302, at least one signal is received. For example, the at least one signal may be received by a receiver in communication with the server. Such a receiver may include any type of receiver adapted to receive a transmitted signal, such as an electromagnetic signal, wirelessly and/or by wire, via the internet or by any other suitable protocol. The receiver may include a module or component of a circuit, chip, or device that is adapted to receive a signal via an input or via a wired or wireless connection.

As noted above, the signal received in block 302 may include one or more of a location and/or a speed (scalar or vector); and/or information from which a location and/or a speed (scalar or vector) can be determined. Further as discussed above, the received signal may originate at the mobile device, at a communication tower, or at a satellite. At block 304, the current location and speed of the mobile device is determined, either by simply reading the location and speed from the received signal, calculating the location and speed based upon information in the received signal, or otherwise interpreting the received signal to determine the location and speed.

At block 306, the user activity is determined based upon the location and speed. The user activity may be determined, for example, by examining a database in communication with the server. Embodiments of methods of determining user activity are discussed below.

At block 308, a message is selected based upon the determined activity. The message may be chosen from a message database in communication with the server. For example, in embodiments the message database may include a list of messages associated with each of the available activities. The component that selects the message may retrieve the list of messages associated with the activity determined in step 306 and select one at random or according to any other order. As noted above, the message may include an advertisement, travel advisory, traffic information, other news message, or any other message. The message is transmitted at block 308 by a transmitter in communication with the server.

FIG. 3B illustrates a process that may be implemented, for example, at a mobile device such as mobile device 104 or GPS device 202 discussed above. At block 312, at least one signal is received. For example, the at least one signal may be received by a receiver incorporated in the mobile device. Such a receiver may include any type of receiver adapted to receive a transmitted signal, such as an electromagnetic signal, wirelessly and/or by wire, via the internet or by any other suitable protocol. The receiver may include a module or component of a circuit, chip, or device that is adapted to receive a signal via an input, wirelessly and/or by wire, via the internet or by any other suitable protocol.

The signal received in block 312 may include signals from GPS satellites, GSM signals from cell towers, or any other information from which a location and/or a speed (scalar or vector) of the mobile device can be determined. At block 314, the current location and speed of the mobile device is determined, for example by calculating the location and speed based upon information in the received signal, or otherwise interpreting the received signal to determine the location and speed.

At block 316, the user activity is determined based upon the location and speed. The user activity may be determined, for example, by examining a database local to the mobile device. Embodiments of methods of determining user activity are discussed below. At block 318, the activity is transmitted to the server.

In an alternative embodiment, instead of determining the user activity itself (block 316), the mobile device transmits its location and speed information determined in block 314 to the server, and the server determines the activity based upon the location and speed information.

Either way, the server selects a message based upon the received (or determined) activity and transmits the message, which is received by a receiver at the mobile device in block 320. As noted above, the message may include an advertisement, travel advisory, traffic information, other news message, or any other message. Upon receiving the message, the mobile device may display the message to the user, for example, on a screen incorporated into the mobile device. The message may include pictures, text, sounds, video, or any combination of the above.

### Determining the User Activity Based Upon Location and Speed Information.

As noted above, once the user's speed and location have been determined, the system can then refer to a database or other data structure to determine a user activity. Once the activity is determined, a message (such as an advertisement, travel advisory, traffic information, other news message, or any other message) can be selected based upon the activity for transmission to the user. In embodiments, the system includes a data structure that stores activity templates linking activities with locations and speeds. Activity templates or any other structure associating activities, locations, and/or speeds may include any type of data structure, including a flat file based structure, or a data structure resident in either the device or server memory or long-term storage. In the discussion herein, the terms “database” or “data structure” may be used, but they should be understood to refer to any suitable structure for storing activities, locations, and/or speed.

For example, when the user's activity is highway driving, the user can be expected to maintain a relatively uniform speed of motion fitting known driving patterns (for example, speeds within the bounds of normal driving activity, along known roadways). Thus, in embodiments, an example of an activity template would link the activity “highway driving” with speeds in a particular range and locations along a highway. Once it has been determined that a user's activity is highway driving, one or more advertisements, travel advisories, or other messages relevant to the needs of a highway driver can be transmitted to the user's mobile device. Examples include advertisements for products or services located geographically close to the user at the time the message is delivered, products or services located en-route to the projected destination, or products or services located at a projected destination of the user.

As another example, when the user's activity is running, a the user may move at a speed slower than driving, but faster than walking, in locations along known roadways, in parks, or in other recreational areas. The running user may move in repeating patterns, such as circling a path within a park several times. Thus, in embodiments, an example of an activity template would link the activity “running” with speeds of, for example, between 4 and 14 mph, in locations within a park. Once it has been determined that the user is running, one or more relevant messages such as advertisements for products or services useful to someone exercising can be displayed. These may include, for example, items such as exercise drinks, services provided by a local physical therapist, or nearby restaurants. Non-advertising messages such as weather conditions may be provided. In embodiments, other conditions may be combined with the user activity to further refine selection of the message. For example, where the activity is determined to be running and the weather conditions indicate rain, advertisements can be transmitted for nearby indoor establishments where the runner may seek shelter.

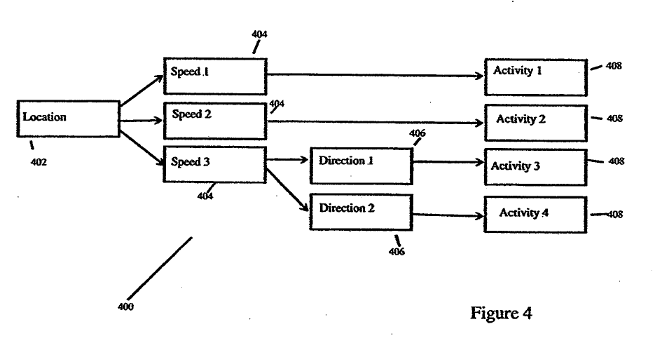

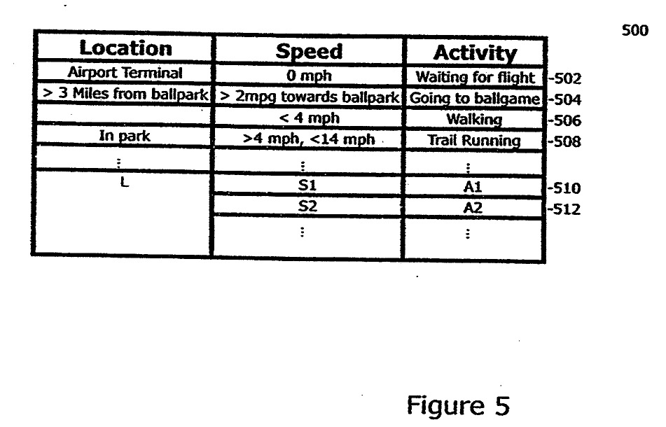

FIGS. 4 and 5 schematically illustrate examples of activity templates (for example, database structures) that can be implemented to link user activities with determined locations and speeds. As noted above, activity templates or any other structure associating activities, locations, and/or speeds may include any type of data structure, including a flat file based structure, or a data structure resident in either the device or server memory or long-term storage. In the discussion herein, the terms “template” or “data structure” may be used, but they should be understood to refer to any suitable structure for storing activities, locations, and/or speed.

FIG. 4 schematically illustrates an embodiment of a template (structure) 400 that can be used to determine a user activity based upon a determined current location and a determined current speed. In the following discussion, it will be assumed that the server is determining the user activity, but it should be understood that template (structure) 400 may be implemented in components of a mobile device, GPS device, or server such as discussed above.

In embodiments, the server retrieves a location 402 from the database. As noted previously, a location may be stored at any level of specificity, including location coordinates (or a range of coordinates), a general class of location (e.g., hotel, airport, highway, supermarket, private home), or a specific location (e.g., at a MARRIOTT hotel, at the Boston-Cambridge MARRIOTT hotel, on I-90, at Logan airport). Location entries in the database may include one or more of the above types.

Associated with location 402 in the database are one or more speeds 404. Speeds may be specified, for example, as numbers, as numeric ranges, and/or as a combination of both. The server looks for a speed 404 that matches the determined current speed of the mobile device. The matching speed 404 may be a range of speeds into which the current speed of the mobile device falls. Associated with speeds 404 in the template (structure) 400 are activities 408.

In embodiments, and for some activities, the matching speed together with the selected location are sufficient to determine the activity. For example, in FIG. 4, where location 402 is the mobile device's location and SPEED 1 matches the current speed of the mobile device, the user activity can be determined to be ACTIVITY 1. Where SPEED 2 matches the current speed of the mobile device, the user activity can be determined to be ACTIVITY 2.

In embodiments, a direction of motion is computed in addition to location and speed, and the template (structure) 400 also includes directions 406 that can be used to determined the user activity. So, for example, where SPEED 3 matches the current speed of the mobile device and DIRECTION 1 matches the direction of motion, ACTIVITY 3 can be determined to be the user activity. Likewise, where SPEED 3 matches the current speed of the mobile device and DIRECTION 2 matches the direction of motion, ACTIVITY 4 can be determined to be the user activity. Directions 406 may be particular to the nature of location 402. For example, where location 402 is a highway, directions 406 may include specifications such as “northbound,” “southbound,” “eastbound,” “westbound,” etc. Where location 402 is a location such as “within 4 miles of a ballpark,” directions 406 may include specifications such as “toward the ballpark,” “away from the ballpark,” etc. Other types of direction specification will be appreciated.

It should be noted that while template (structure) 400 shows a location entry 402 and associated speed entries 404, alternatives to template (structure) 400 may be used in some embodiments. For example, the server may first find a speed entry in the database that matches the speed of the mobile device, and then look at locations associated with the matching speed entry to find a matching location. The location-speed pair (or, where appropriate, the location-speed-direction triplet) thus identified can the be to select an associated user activity.

FIG. 5 schematically illustrates an embodiment of a template (structure) 500 that can be used to determine a user activity based upon a determined current location and a determined current speed. The template (structure) 500 includes a table associating locations and speeds (with or without directions) with activities. For example, row 502 associates the location AIRPORT TERMINAL and the speed 0 mph with the activity WAITING FOR FLIGHT. Row 504 associates the location <3 MILES FROM BALLPARK and the speed >2 MPH TOWARD BALLPARK with the activity GOING TO BALLGAME. Rows 506 and 508 illustrate that more than one activity can be associated with a single location. For example, row 506 associates the location IN PARK and the speed <4 MPH with the activity WALKING, while row 508 associates the location IN PARK and the speed >4 MPH, <14 MPH with the activity TRAIL RUNNING. More generally, a location L may be associated with multiple speeds S₁, S₂, etc., and location-speed pairs (L, S₁), (L, S₂), etc. may be associated with activities A₁, A₂, etc., as illustrated by rows 510, 512.

It should also be noted that templates (structures) 400 and 500 are presented only as examples database structures that can be used in a system for identifying a user activity. Any other suitable structure that links user activities with locations, speeds, and/or directions may be used. In further embodiments, the templates 400 or 500 could be expanded to include any number of recent locations and speeds as well as current locations and speeds, such that the current activity could be determined based upon a history of locations and speeds. Thus could permit more precise identification of activities. Likewise, the selection of a message could be based upon an activity history comprising any number of recent activities as well as a current activity, which could enable a more precisely targeted selection of message.

In embodiments, mobile device 104, GPS device 202, or server 108/206 may determine the user activity according to any of the methods described above, and adaptively learn the habits of a particular user after a number of activities have been determined. For example, the mobile device 104, GPS device 202, or server 108/206 may record a history of user activities. Such device may use the history of user activities to build a table or other data structure of the user's most common or most likely activities. Such a table of activities may include, for example, the user's most likely activity for each of a number of particular locations or for each of a number of particular locations. In embodiments, where the mobile device 104, GPS device 202, or server 108/206 determines the user's location and/or speed, it may choose from a number of activities associated with that location and/or speed by selecting the most likely activity according to the user's history.

In embodiments, a history, table, or other data structure of user activities may be improved over time with input from the user. For example, where the user's location is inside a park and the user's speed is >4 mph, the mobile device 104 or GPS device 202 may provisionally select the activity TRAIL RUNNING and request confirmation from the user. (In embodiments in which server 108/206 determines the activity, server 108/206 may make the provisional selection of activity and send a message to the mobile device 104 or GPS device 202 instructing it to request confirmation from the user and return confirmation to the server 108/206.) In embodiments, once a user has confirmed a provisional choice of activity for a particular location and/or speed, if the same location and/or speed are observed at a later instance, the mobile device 104, GPS device 202, or server 108/206 may select the same activity without the additional step of receiving confirming input.

As another example of a way to use a history of user locations and/or activities to determine a targeted message, where a user is a frequent traveler, the mobile device 104, GPS device 202, or server 108/206 (whichever stores activity templates and determines the activity, in various embodiments), may include a history of the user's locations including frequent stays at a particular brand of hotel. Upon determining the user's location to be in an airport, the server 108/206 may select a message for transmission to the mobile device 104 or GPS device 202 that includes an advertisement for a nearby hotel of the same brand.

Having thus described several aspects of examples of embodiments, it is to be appreciated various alterations, modifications, and improvements will readily occur to those skilled in the art. Such alterations, modifications, and improvements are intended to be part of this disclosure, and are intended to be within the spirit and scope of the embodiments and methods that may be supported by the present disclosure. It should be understood that the systems and methods disclosed herein are not limited to each of the described embodiments and their variations; embodiments may be practiced alone or in combination with other embodiments. Accordingly, the foregoing description and drawings are by way of example only.

What is claimed is:

1. A method comprising:
receiving at least one first signal;
determining, based at least in part upon the at least one first signal, a current location and a current speed of a device;
determining an activity of a user of the device based at least in part upon at least one of the device's current location and the device's current speed;
selecting a message based at least in part upon the activity of the user; and
transmitting the message.

2. The method of claim 1, wherein:
the at least one first signal is transmitted by the device.

3. The method of claim 2, wherein:
the at least one first signal comprises at least two GSM signals transmitted by the device.

4. The method of claim 2, wherein:
the at least one first signal comprises a signal encoding the device's current location and the device's current speed.

5. The method of claim 4, wherein:
the device's current location and the device's current speed are determined by the device.

6. The method of claim 5, wherein:
the device's current location and the device's current speed are determined based at least in part upon a plurality of second signals.

7. The method of claim 6, wherein:
the plurality of second signals comprises a plurality of GSM signals.

8. The method of claim 6, wherein:
the plurality of second signals comprises a plurality of GPS signals.

9. The method of claim 1, wherein determining the activity of the user further comprises determining the activity of the user based at least in part upon the device's current speed and direction.

10. The method of claim 1, wherein determining the device's current location further comprises determining a class of location.

11. The method of claim 1, wherein determining the device's current location further comprises determining a specific location.

12. The method of claim 1, wherein determining the activity of the user further comprises selecting from a plurality of activities an activity having an activity template most closely matching the device's current location and current speed.

13. The method of claim 12, wherein determining the activity of the user further comprises selecting from a plurality of activities an activity having an activity template most closely matching the device's current location, current speed, and current direction.

14. The method of claim 1, wherein the message is an advertisement.

15. The method of claim 14, wherein the advertisement advertises a product or service selected based at least in part upon the user activity.

16. A system comprising:
a receiver adapted to receive at least one first signal;
a component adapted to determine, based at least in part upon the at least one first signal, a current location and a current speed of a device;
a component adapted to determine an activity of a user of the device based at least in part upon at least one of the device's current location and the device's current speed;
a component adapted to select a message based at least in part upon the activity of the user; and
a transmitter adapted to transmit the message.

17. The system of claim 16, wherein:
the at least one first signal is transmitted by the device.

18. The system of claim 17, wherein:
the at least one first signal comprises at least two GSM signals transmitted by the device.

19. The system of claim 17, wherein:
the at least one first signal comprises a signal encoding the device's current location and the device's current speed.

20. The system of claim 19, wherein:
the device's current location and the device's current speed are determined by the device.

21. The system of claim 20, wherein:
the device's current location and the device's current speed are determined based at least in part upon a plurality of second signals.

22. The system of claim 21, wherein:
the plurality of second signals comprises a plurality of GSM signals.

23. The system of claim 21, wherein:
the plurality of second signals comprises a plurality of GPS signals.

24. The system of claim 16, wherein the component adapted to determine the activity of the user is further adapted to determine the activity of the user based at least in part upon the device's current speed and direction.

25. The system of claim 16, wherein the component adapted to determine the device's current location is further adapted to determine a class of location.

26. The system of claim 16, wherein the component adapted to determine the device's current location is further adapted to determine a specific location.

27. The system of claim 16, wherein the component adapted to determine the activity of the user is further adapted to select from a plurality of activities an activity having an activity template most closely matching the device's current location and current speed.

28. The system of claim 27, wherein the component adapted to determine the activity of the user is further adapted to select from a plurality of activities an activity having an activity template most closely matching the device's current location, current speed, and current direction.

29. The system of claim 16, wherein the message is an advertisement.

30. The system of claim 29, wherein the advertisement advertises a product or service selected based at least in part upon the user activity.

31. A mobile device comprising:
a transmitter adapted to send at least one first signal;
a message comprising content that is based at least in part upon a selected activity of a user of the mobile device, wherein the activity is selected based at least in part upon the at least one first signal; and
a receiver coupled to the transmitter and adapted to receive the message.

32. The mobile device of claim 31, wherein:
the at least one first signal comprises at least two GSM signals.

33. The mobile device of claim 31, wherein:
the at least one first signal comprises a second signal encoding a current location of the mobile device and a current speed of the mobile device.

34. The mobile device of claim 33, further comprising:
a component adapted to determine the current location of the mobile device and the current speed of the mobile device.

35. The mobile device of claim 34, wherein:
the component is further adapted to determine the current location of the mobile device and the current speed of the mobile device based at least in part upon a plurality of third signals.

36. The mobile device of claim 35, wherein:
the plurality of third signals comprises a plurality of GSM signals.

37. The mobile device of claim 35, wherein:
the plurality of third signals comprises a plurality of GPS signals.

38. The system of claim 31, further comprising a display adapted to display at least a portion of the message.

39. A system comprising:
a component adapted to receive a plurality of first signals;
a component adapted to determine, based at least in part upon at least some of the plurality of first signals, a current location and a current speed of the system;
a component adapted to determine an activity of a user of the system based at least in part upon at least one of the current location of the system and the current speed of the system;
a transmitter adapted to transmit the activity of the user; and
a component adapted to receive a message based at least in part upon the activity of the user.

40. The system of claim 39, wherein:
the plurality of first signals comprises a plurality of signals emitted by at least one cell tower.

41. The system of claim 39, wherein:
the plurality of first signals comprises a plurality of signals emitted by a plurality of GPS satellites.

42. The system of claim 39, wherein:
the component adapted to determine the current location of the system and current speed of the system is further adapted to determine a current direction of the system.

43. The system of claim 39, wherein:
the component adapted to determine the activity of the user is further adapted to determine the activity of the user based at least in part upon at least one of the system's current location, the system's current speed, and the system's current direction.

44. The system of claim 39, further comprising a display adapted to display at least a portion of the message.

45. The system of claim 39, wherein the component adapted to determine the system's current location is further adapted to determine a class of location.

46. The system of claim 39, wherein the component adapted to determine the system's current location is further adapted to determine a specific location.

47. The system of claim 39, wherein the component adapted to determine the activity of the user is further adapted to select from a plurality of activities an activity having an activity template most closely matching the system's current location and current speed.

48. The system of claim 47, wherein the component adapted to determine the activity of the user is further adapted to select from a plurality of activities an activity having an activity template most closely matching the user's current location, current speed and current direction.

49. The system of claim 39, wherein the message is an advertisement.

50. The system of claim 49, wherein the advertisement advertises a product or service selected based at least in part upon the user activity.

51. A method comprising:
receiving a plurality of first signals;
determining, based at least in part upon at least some of the plurality of first signals, a current location and a current speed of a device;
determining an activity of a user of the device based at least in part upon at least one of the device's current location and the device's current speed;
transmitting the activity of the user; and
receiving a message based at least in part upon the activity of the user.

52. The system of claim 51, wherein:
receiving the plurality of first signals comprises receiving a plurality of signals emitted by at least one cell tower.

53. The system of claim 51, wherein:
receiving the plurality of first signals comprises receiving a plurality of signals emitted by a plurality of GPS satellites.

54. The system of claim 51, wherein:
determining the current location of the device and current speed of the device further comprises determining a current direction of the device.

55. The system of claim 54, wherein:
determining the activity of the user further comprises determining the activity of the user based at least in part upon at least one of the device's current location, the of the device's current speed, and the device's current direction.

56. The method of claim 51, further comprising displaying at least a portion of the message.

57. The method of claim 51, wherein determining the device's current location further comprises determining a class of location.

58. The method of claim 51, wherein determining the device's current location further comprises determining a specific location.

59. The method of claim 51, wherein determining the activity further comprises selecting from a plurality of activities an activity having an activity template most closely matching the device's current location and current speed.

60. The method of claim 59, wherein determining the activity further comprises selecting from a plurality of activities an activity having an activity template most closely matching the device's current location, current speed, and current direction.

61. The method of claim 51, wherein the message is an advertisement.

62. The system of claim 61, wherein the advertisement advertises a product or service selected based at least in part upon the user activity.
